(19) United States
(12) Patent Application Publication
(10) Pub. No.: US 2024/0041170 A1
(43) Pub. Date: Feb. 8, 2024

(54) OUTDOOR UMBRELLA WITH LIGHT EFFECT

(71) Applicant: TAIZHOU COSY LEISURE CO., LTD, Zhejiang (CN)

(72) Inventors: Jianping KE, Zhejiang (CN); Fuqiang KE, Zhejiang (CN)

(73) Assignee: TAIZHOU COSY LEISURE CO., LTD, Zhejiang (CN)

(21) Appl. No.: 17/760,772

(22) PCT Filed: Jan. 27, 2022
(86) PCT No.: PCT/CN2022/074167

§ 371 Date: Jul. 27, 2023

(30) Foreign Application Priority Data
Jan. 24, 2022 (CN) 202220187083.X

(51) Int. Cl. A45B 25/02; A45B 23/00; F21S 4/28

(52) U.S. Cl. CPC A45B 25/02; A45B 23/00; F21S 4/28; A45B 2023/0012; A45B 2023/0037; A45B 2200/1018; A45B 2200/1027

(57) ABSTRACT

An outdoor umbrella with a light effect is provided. The outdoor umbrella includes an umbrella stand which is covered with umbrella cloth; the umbrella stand includes an umbrella plate assembly and a plurality of umbrella rib assemblies in fit with the umbrella plate; the umbrella rib assembly includes a plurality of umbrella rib units, wherein at least one of the umbrella rib units is provided with a light groove along a length direction, and a light assembly includes a light-emitting body and a light-transmissive tube wrapping the outer side of the light-emitting body, the light-transmissive tube is used for being completely or partially embedded into the light groove, and the light-transmissive tube is arranged along the length direction of the umbrella rib unit. The light assembly structure is optimally designed, and the light-emitting body is sleeved with the light-transmissive tube to form an integrated structure.

### FIELD OF TECHNOLOGY

The present invention relates to the technical field of outdoor umbrellas, and in particular relates to an outdoor umbrella with a light effect.

### BACKGROUND

As an outdoor leisure appliance, the outdoor umbrella is widely used in squares, beaches, parks and courtyards and other leisure places to provide a comfortable space for people to cool off. The outdoor umbrella is widely applied to various outdoor rest and diet areas, which can be used for protecting the people from the rays of the scorching sun and the pouring of the rainwater through the sun-shading and rain-shielding functions of the outdoor umbrella when engaged in leisure activities in outdoor places, thus obtaining a good and comfortable rest environment.

Most of common outdoor umbrella structures are provided with a middle umbrella column, the upper section of the middle umbrella column is sleeved with umbrella ribs which can be expanded outwards and are in a radial shape, and then the upper end faces of the umbrella ribs are covered with umbrella cloth. As the light is unclear at night, the range under the outdoor umbrella is dim, for this reason, most of existing outdoor umbrellas may be provided with a light structure to improve illumination or to increase light sensation atmosphere.

For example, an umbrella rib and lamp bead connecting structure of a sunshade is disclosed in the patent with publication number of CN209711801U, and belongs to the field of leisure furniture appliances. The structure includes an umbrella rib, a substrate is arranged in the umbrella rib, a plurality of LED lamp beads are arranged on the substrate, and a lamp holder corresponding to the LED lamp bead is arranged at a position of each LED lamp bead; a clamping and embedding cavity is formed in the lamp holder, a lamp hole is formed in a position, corresponding to the clamping and embedding cavity, of the umbrella rib, a lampshade can penetrate through the lamp hole and can be inserted into the clamping and embedding cavity; and the lampshade can be prevented from moving reversely to separate from the lamp holder after being inserted into the clamping and embedding cavity. The plurality of LED lamp beads need to be installed on the umbrella rib in the technical solution. However, the umbrella rib strength is reduced as each umbrella rib needs to be drilled in the production, thus the sun umbrella is easy to break. In addition, it is time-consuming and labor-consuming to install the LED lamp bead into the hole, the conductive butt joint of various lamp beads is relatively tedious, which makes the overall installation more complex.

To this end, a novel light umbrella is disclosed in the patent with publication number of CN104665138B, and belongs to the technical field of sunshades. The novel light umbrella includes a lower umbrella plate and an upper umbrella plate fixed to the top end of an umbrella pole; one end of a long umbrella rib is hinged to the upper umbrella plate, and the other end of the long umbrella rib is used for opening umbrella cloth; one end of a short umbrella rib is hinged to the lower umbrella plate, and the other end of the short umbrella rib is hinged to the middle of the long rib, wherein a groove is formed in the long rib or the short rib or one of the long rib and the short rib, a light-emitting device is arranged in the groove and includes a light-guide strip; the light-guide strip is clamped in the groove, the end face of the light-guide strip is provided with a light source, the light source is fixed to a fixed base, and the fixed base is fixedly connected to the umbrella rib and sleeved with a plug for protection. The outdoor umbrella disclosed by the present invention is reasonable in design, the light-guide strip is arranged on the short rib, then SMD LED lamps are tightly attached to the light-guide strip for continuous refraction and reflection to form a light band, thus achieving excellent effects of lighting and beautifying the night environment. However, due to a light-emitting structure at the end part of the structure, the overall illumination intensity is relatively poor and the lighting is reluctant. As a substrate structure in an internal light-guide strip is generally made of a rigid material, in the long-term use of the leisure umbrella, especially in the later period, the umbrella rib may be bent at a certain radian due to the use time limit or the influence of external wind and rain, the inner substrate may be damaged in serious cases, seriously affecting the service life.

To make up the defects in the existing light umbrella, an outdoor light umbrella which is simple and convenient in production and manufacturing, low in manufacturing cost and good in light effect is designed at present, and more choices are provided for the consumer.

### SUMMARY

For the problems, the present invention aims to provide an outdoor umbrella with a light effect, which has the features of being good in light effect, low in cost, and convenient for assembly.

The technical problem solved by the present invention may be achieved by adopting the following technical solutions.

An outdoor umbrella is provided, including an umbrella stand which is covered with umbrella cloth, wherein the umbrella stand includes an umbrella plate assembly and a plurality of umbrella rib assemblies in fit with the umbrella plate; the umbrella rib assembly includes a plurality of umbrella rib units, wherein at least one umbrella rib unit is provided with a light groove along a length direction, and a light assembly includes a light-emitting body and a light-transmissive tube wrapping the outer side of the light-emitting body, the light-transmissive tube is used for being completely or partially embedded into the light groove, and the light-transmissive tube is arranged along the length direction of the umbrella rib unit.

One end of the light-emitting body is connected to a terminal part through wires, and the terminal part is used for being in conductive butt joint with a terminal base; the terminal base is located on a master control part; a plurality of terminal bases are arranged on the master control part, and the single terminal base is used for being in fit with a single terminal part.

The master control part is used for being in fit with the umbrella plate assembly for installation, and a power module is further conductively connected to the master control part.

The power module includes a solar panel and a power storage module electrically connected to the solar panel.

The power module includes a battery holder and a battery module detachably installed on the battery holder, and the battery holder is used for being in fit with the umbrella plate assembly or an umbrella column for installation.

A groove opening of the light groove is formed downwards, and the light groove includes a groove cavity body and clamping protruding edges, the clamping protruding edges are located at two sides of an opening of the groove cavity body, and the clamping protruding edges at the two sides are used for limiting the light-transmissive tube.

The outdoor umbrella further includes a diagonal brace, one end of the diagonal brace is in fit with the umbrella plate assembly, and the other end of the diagonal brace is in fit with the umbrella column; and the diagonal brace is provided with a light groove, and a light assembly is arranged in the light groove in a fitting manner.

The light-emitting body employs LED copper wire light strings.

The light-transmissive tube is one of a flexible matte hollow tube, a flexible bright hollow tube, a rigid matte hollow tube, or a rigid bright hollow tube.

The light-emitting body in the light-transmissive tube is a single LED copper wire light string, and a plurality of LED lamp beads are arranged in the single LED copper wire light string.

Compared with the prior art, the present invention has the following beneficial effects: a light assembly structure is optimally designed, and the light-emitting body is sleeved with the light-transmissive tube to form an integrated structure, thus facilitating the assembly with the light groove in the umbrella rib unit, reducing the assembly difficulty as well as reducing the production cost. An installation structure of the light assembly and the master control part in the single umbrella rib unit is optimized to facilitate the integrated control assembly of the plurality of umbrella rib units.

The features of the present invention can be clearly understood by referring to the drawings of the present invention and the detailed description of the following preferred embodiments.

### BRIEF DESCRIPTION OF THE DRAWINGS

FIG. 1 is a structure diagram illustrating the installation of an umbrella rib unit and a light assembly of the present invention;

FIG. 2 is a structure diagram of the light assembly of the present invention;

FIG. 3 is a structure diagram illustrating the installation of the umbrella rib unit, the light assembly, a master control part, and a power module of the present invention;

FIG. 4 is a sectional structure diagram illustrating the installation of the umbrella rib unit and the light assembly of the present invention;

FIG. 5 is a first structure diagram of the umbrella rib unit of the present invention;

FIG. 6 is a second structure diagram of the umbrella rib unit of the present invention;

FIG. 7 is a first structure diagram of a middle column umbrella of an embodiment 2 of the present invention;

FIG. 8 is a second structure diagram of the middle column umbrella of an embodiment 2 of the present invention;

FIG. 9 is a first structure diagram of a side column umbrella of an embodiment 3 of the present invention;

FIG. 10 is a second structure diagram of the side column umbrella of an embodiment 3 of the present invention.

In the drawings: 1—umbrella rib unit, 11—light groove, 111—groove cavity body, 112—clamping protruding edge, 2—light assembly, 21—light-transmissive tube, 22—light-emitting body, 23—terminal part, 24—wire, 3—master control part, 31—terminal base, 32—starting switch, 33—remote controller, 4—power module, 51—upper umbrella plate, 52—lower umbrella plate, 6—umbrella column, 7—umbrella cloth, 8—diagonal brace.

### DESCRIPTION OF THE EMBODIMENTS

To make the technical means, creative features, achievement goals and effects achieved by the present invention easy to understand, the present invention will be further described below in conjunction with specific illustrations.

### Embodiment 1

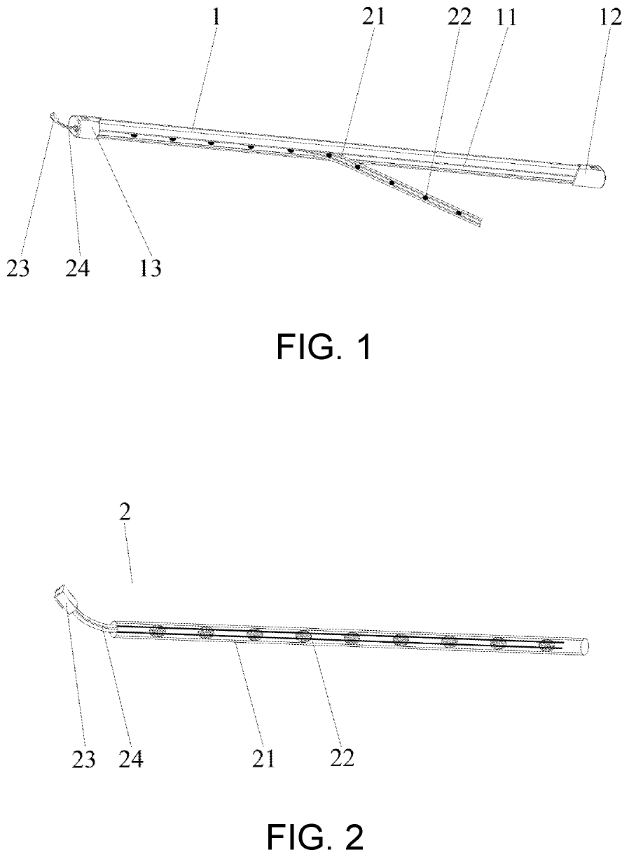

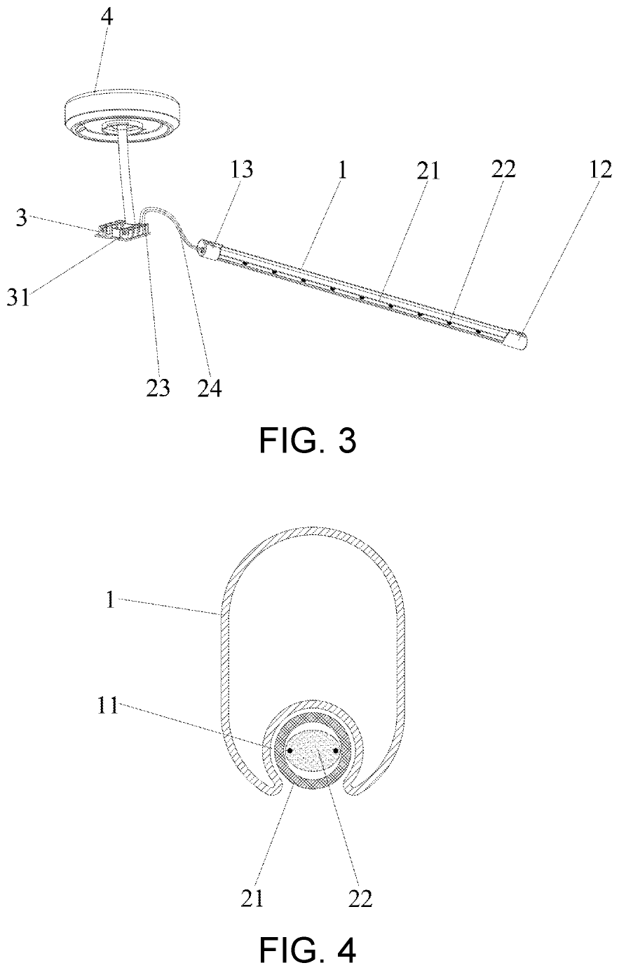

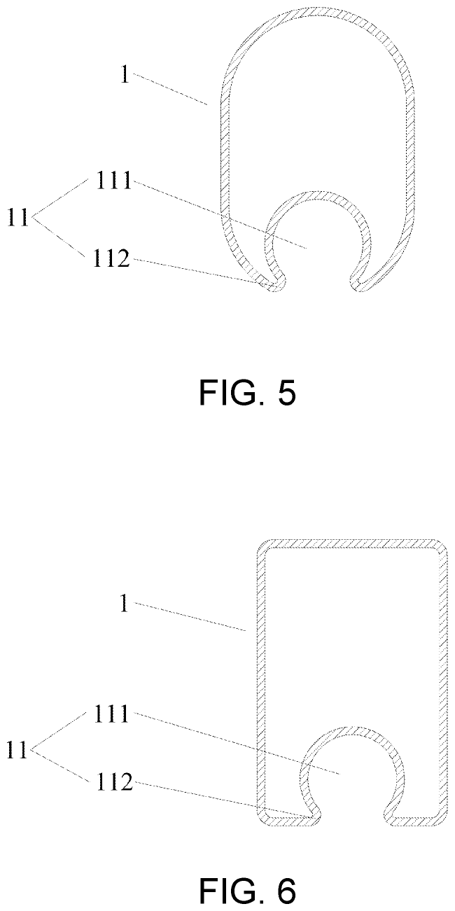

As shown in FIG. 1 to FIG. 10, an umbrella rib unit with a light effect is disclosed in the embodiment, wherein a plurality of umbrella rib units 1 are combined to form an umbrella unit assembly; the umbrella rib units 1 can be divided into long umbrella rib units, short umbrella rib units, top umbrella rib units, and the like according to different specifications of the outdoor umbrellas. For example, in a middle column umbrella, the umbrella rib units are usually divided into long umbrella rib units and short umbrella rib units; in a Roman umbrella, the umbrella rib units are usually divided into long umbrella rib units, short umbrella rib units, and a diagonal brace; and in a case of a Roman umbrella with a double-top structure, the umbrella rib units may also include top umbrella rib units.

Wherein at least one umbrella rib unit 1 is provided with a light groove 11 along a length direction. According to the product demands of the outdoor umbrella, the section of the umbrella rib of the umbrella rib unit 1 may be a round umbrella unit, an oval umbrella rib, a square umbrella rib, and the like. Preferably, the long umbrella rib unit or/and the short umbrella rib unit is/are provided with a light groove 11 along a length direction, and the light groove 11 is used for being in fit with a light assembly 2 for installation, thus achieving the assembly of the umbrella rib unit 1 with the light effect; wherein the light assembly 2 includes a light-emitting body 22 and a light-transmissive tube 21 wrapping on the outer side of the light-emitting body 22, and the light-transmissive tube 21 is used for being completely or partially embedded into the light groove 11, and the light-transmissive tube is arranged along the length direction of the umbrella rib unit 1.

Specifically, a groove opening of the light groove 11 is formed downwards, the light groove 11 includes a groove cavity body 111 and clamping protruding edges 112, the clamping protruding edges 112 are located at two sides of an opening of the groove cavity body 111, and the clamping protruding edges 112 at the two sides are used for limiting the light-transmissive tube 21. The structure of the light groove 11 is optimized to limit the light-transmissive tube 21 using the clamping protruding edges 112, thus preventing the light-transmissive tube 21 from detaching, where the light-transmissive tube 21 may be in a variety of tube shapes according to the usage demands.

Preferably, the light-emitting body 22 employs LED copper wire light strings, the light-emitting body 22 in the light-transmissive tube 21 is a single LED copper wire light string, and a plurality of LED lamp beads are arranged in the single LED copper wire light string; and a spacing distance between the LED lamp bead at the head end and the LED lamp bead at the tail end in the single LED copper wire light string is smaller than the length of the light-transmissive tube.

Wherein the LED copper wire light strings employ common components in the prior art, for example, a copper wire lamp is disclosed in CN209672111U, relating to the technical field of decorative appliances. The technical problem of poor protection measures of the LED light string in the prior art is solved. The device includes a lead wire and light-emitting sources, wherein the light-emitting sources are connected to the lead wire and are distributed along a length direction of the lead wire at intervals, and the light-emitting source is wrapped with light-transmissive colloid outside; the copper wire lamp can be bent into any shapes and is connected to a bearing part; and when the lead wire is connected to a power supply, the light-emitting sources can emit light.

In this embodiment, preferably, the rest light-transmissive tubes 21 are well combined to reduce the cost of the light-emitting body 22; by adopting the existing LED copper wire light strings for the replacement and in combination with the assembly of the light-transmissive tube 21 and the umbrella rib unit 1, the overall assembly of the umbrella rib unit with the light effect can be achieved, the production cost is reduced, the overall cost is low, and the outdoor umbrella has a good application market.

A structure of the light groove 11 is optimized to facilitate the assembly with the light-transmissive tube 21, thus reducing the difficulty of the overall assembly process to achieve low-cost manufacturing; and the good light effect can also be guaranteed at the same time.

Wherein, in accordance with a groove structure of the light groove 11 in the umbrella rib unit 1, the section of the light-transmissive tube 21 may be a round tube, a square tube, a triangular tube, a polygonal tube, a special tube, and the like, and can be correspondingly adjusted according to user demands or appearance aesthetic demands.

In one of preferred embodiments, the light-transmissive tube 21 employs a flexible hollow tube, specifically a flexible matte hollow tube or a flexible bright hollow tube, and the matte hollow tube or the bright hollow tube can be selected according to the customer's demands for the light, wherein the flexible hollow tube is adopted to facilitate the assembly with the umbrella rib unit 1, and the light-transmissive tube can be directly filled and assembled through the groove opening of the light groove 11 by using the flexible characteristics thereof.

In an alternative solution in the embodiment, the light-transmissive tube 21 employs a rigid hollow tube, specifically a rigid matte hollow tube or a rigid bright hollow tube, and the matte hollow tube or the bright hollow tube can be selected according to the customer's demands for the light, wherein the light-transmissive tube 21 is usually embedded and installed through the groove opening at the end part of the light groove 11 at the end part of the umbrella rib unit 1, which has relatively better strength.

Based on the above, two ends of the umbrella rib unit 1 may also be in fit with a first end cap 12 and a second end cap 13, the first end cap 12 is located at an outer end of the umbrella rib unit 1 and is usually a blind hole structure to seal the outer end part of the umbrella unit 1; the second end cap 13 is located at an inner end position of the umbrella rib unit 1, and is generally used for being hinged and fitted with one of an upper umbrella plate 51, a lower umbrella plate 52, and a top umbrella plate in the umbrella plate assembly, wherein the second end cap 13 is generally provided with a threading hole or a threading groove to facilitate a guiding direction of the light-emitting body 22 to extend outwards, and a terminal part 23 connected to the wires 24 in the light-emitting body 22 is located at the outside of the second end cap 13.

Through optimal design in the embodiment, the assembly of the umbrella rib unit 1 and the light assembly 2 is simpler, and the light effect is guaranteed at the same time. The light-emitting body 22 is sleeved with the light-transmissive tube 21 to form an integrated structure, thus facilitating the assembly with the light groove 11 in the umbrella rib unit 1, reducing the assembly difficulty as well as reducing the production cost.

### Embodiment 2

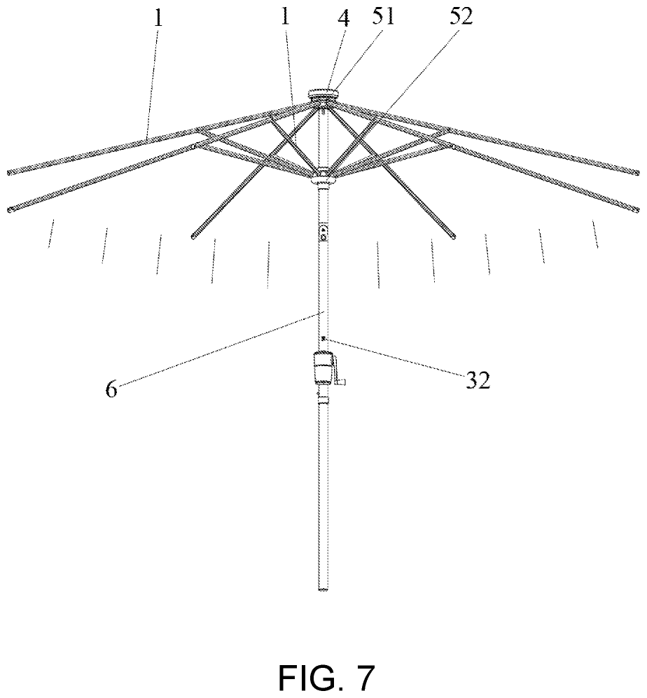

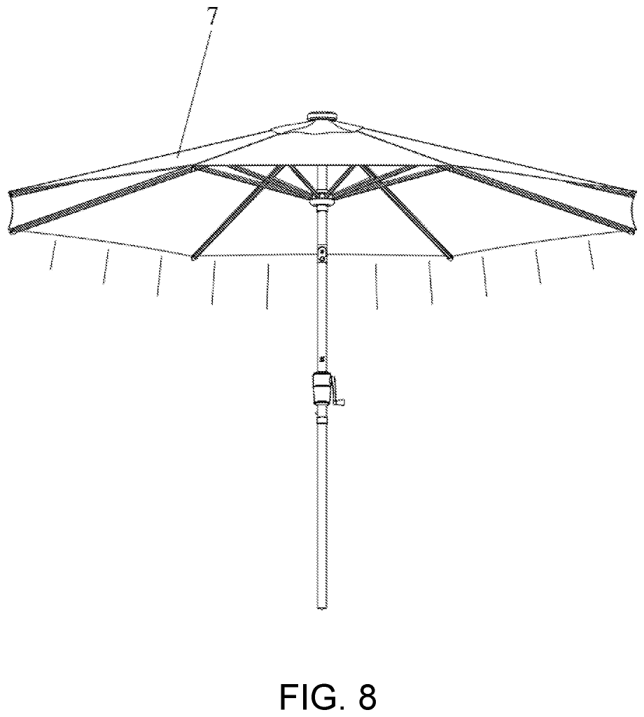

Based on the embodiment 1, as shown in FIG. 7 and FIG. 8, an outdoor umbrella with a light effect is disclosed in the embodiment. The outdoor umbrella in the embodiment is of a middle column umbrella structure, which includes an umbrella stand which is covered with umbrella cloth 7; the umbrella stand includes an umbrella plate assembly and a plurality of umbrella rib assemblies in fit with the umbrella plate assembly, and the umbrella rib assembly includes a plurality of umbrella rib units 1, wherein the umbrella rib unit 1 employs the umbrella rib unit 1 with the light effect in the embodiment 1. The umbrella plate assembly includes an upper umbrella plate 51 and a lower umbrella plate 52, and the umbrella rib units 1 are divided into long umbrella rib units and short umbrella rib units, wherein one end of the long umbrella rib unit is hinged and fitted with the upper umbrella plate, and the other end of the long umbrella rib unit is a free end; one end of the short umbrella rib unit is hinged and fitted with the lower umbrella plate, the other end of the short umbrella rib unit is hinged and fitted with the middle of the long umbrella rib unit. The umbrella plate assembly is further in fit with an umbrella column which is centrally provided, and the top end of the umbrella column is in fit with the upper umbrella plate for installation and penetrates through the lower umbrella plate to extend downwards.

Wherein a terminal part 23 is connected to the light-emitting body 22 installed in the umbrella rib unit 1 in a fitting manner through outward-extending wires 24, and the terminal part 23 is used for being in conductive butt joint with a terminal base 31; the terminal base 31 is located on a master control part 3, the master control part 3 is provided with a plurality of terminal bases 31, and the single terminal base 31 is used for being in fit with a single terminal part 23; wherein the master control part 3 is used for being in fit with the umbrella plate assembly for installation, preferably an upper umbrella plate 51, and the master control part is installed in the upper umbrella plate 51. The master control part 3 may also be usually provided with a Bluetooth switch module, an infrared switch module, or connected to a starting switch 32 through a wire; the starting switch 32 may be assembled on the umbrella column 6 to achieve the control starting of the light-emitting body 22, and may also be combined with a remote controller 33 to achieve wireless starting.

Wherein a power module 4 is further conductively connected to the master control part 3.

In one of the embodiments, as shown in FIG. 8, the power module 4 includes a solar panel and a power storage module electrically connected to the solar panel, and the solar panel is usually installed at an upper part of the upper umbrella plate 51 and protrudes from the umbrella cloth 7.

In another alternative embodiment, the power module 4 includes a battery holder and a battery module detachably installed on the battery holder, the battery holder is used for being in fit with the umbrella rib assembly or the umbrella column for installation; the battery module may preferably employ a detachable power supply in the prior art, such as a power bank, a high-capacity battery, and the like, wherein the power module is preferably installed on the umbrella rib unit or the umbrella column.

In another embodiment, the power module may also combine the solar panel, a storage battery module, the battery holder and the battery module for use.

### Embodiment 3

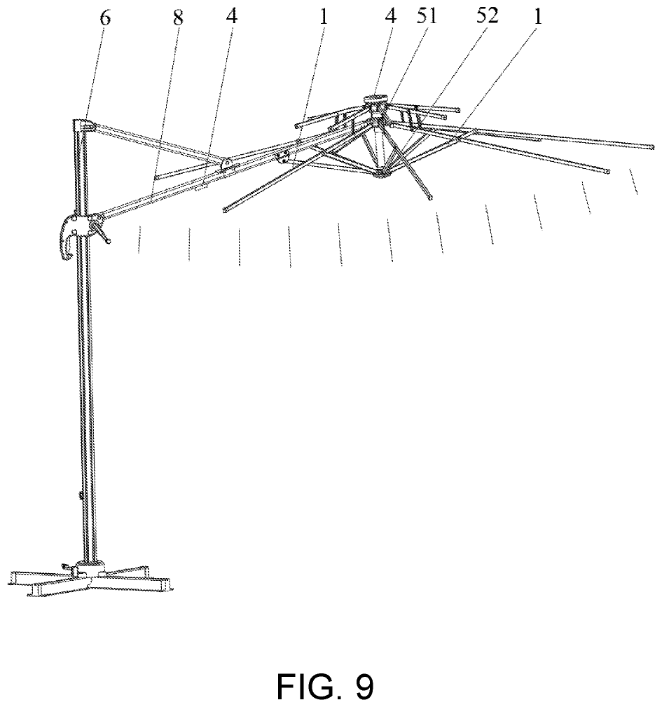

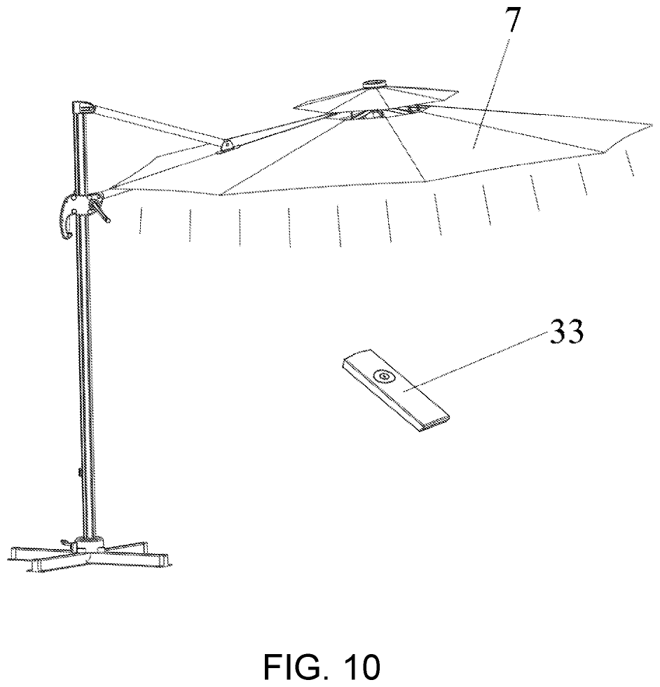

Based on the embodiment 1, with reference to FIG. 9 and FIG. 10, the outdoor umbrella in the embodiment is of a side column umbrella structure, preferably a Roman umbrella, which includes an umbrella stand which is covered with umbrella cloth 7; the umbrella stand includes an umbrella plate assembly and a plurality of umbrella rib assemblies in fit with the umbrella plate assembly, and the umbrella rib unit assembly includes a plurality of umbrella rib units 1, wherein the umbrella rib unit 1 employs the umbrella rib unit 1 with the light effect in the embodiment 1; the umbrella rib assembly includes an upper umbrella plate 51 and a lower umbrella plate 52, and the umbrella rib units 1 are divided into long umbrella rib units and short umbrella rib units, wherein one end of the long umbrella rib unit is hinged and fitted with the upper umbrella plate, and the other end of the long umbrella rib unit is a free end; one end of the short umbrella rib unit is hinged and fitted with the lower umbrella plate, and the other end of the short umbrella rib unit is hinged and fitted with the middle of the long umbrella rib unit. The umbrella plate assembly is further provided with a diagonal brace 8, and the other end of the diagonal brace 8 is in fit with an umbrella column, wherein the diagonal brace 8 is of different corresponding structures according to different side column umbrellas; in a Roman umbrella structure, the other end of the diagonal brace 8 is in fit with an armrest shell in the umbrella column for installation; and in a Banana umbrella, the diagonal brace 8 is usually in fit with a movable seat at the top of the umbrella column for installation. The structure of the diagonal brace is provided according to different umbrella types, preferably, the diagonal brace 8 is provided with a light groove 11 in which a light assembly 2 is arranged in a fitting manner.

Wherein a terminal part 23 is connected to the light-emitting body 22 installed in the umbrella rib unit 1 in a fitting manner through outward-extending wires 24, and the terminal part 23 is used for being in conductive butt joint with a terminal base 31; the terminal base 31 is located on the master control part 3, the master control part 3 is provided with a plurality of terminal bases 31, and the single terminal base 31 is used for being in fit with a single terminal part 23, wherein the master control part 3 is used for being in fit with the umbrella plate assembly for installation, preferably the upper umbrella plate 51, and the master control part is installed in the upper umbrella plate 51. The master control part 3 can also be generally provided with a Bluetooth switch module, an infrared switch module or connected to a starting switch 32 through a wire, and the starting switch 32 may be assembled on the lower umbrella plate to achieve the control starting of the light-emitting body 22, or may also be combined with a remote controller 33 to achieve wireless starting.

Wherein a power module 4 is further conductively connected to the master control part 3.

In one of the embodiments, as shown in FIG. 10, the power module 4 includes a solar panel and a power storage module electrically connected to the solar panel, and the solar panel is usually installed at an upper part of the umbrella plate 51 and protrudes from the umbrella cloth 7.

In another alternative embodiment, the power module 4 includes a battery holder and a battery module detachably installed on the battery holder; the battery holder is used for being in fit with the umbrella rib assembly or the umbrella column for installation; the battery module may preferably employ a detachable power supply in the prior art, such as a power bank, a high-capacity battery and the like, wherein the power module is preferably installed on the umbrella rib unit 1 or the diagonal brace 8.

In another embodiment, as shown in FIG. 9, the power module 4 may also combine the solar panel, a storage battery module, the battery holder and the battery module for use.

The above description is only a preferred embodiment of the present invention, and is not intended to limit the present invention in any way. Any simple changes, equivalent variations, or modifications made to the above embodiments in accordance with the technical principles of the present invention are still within the scope of the present invention.

1. An outdoor umbrella with a light effect, comprising an umbrella stand which is covered with umbrella cloth, wherein the umbrella stand comprises an umbrella plate assembly and a plurality of umbrella rib assemblies in fit with the umbrella plate assembly; the umbrella rib assembly comprises a plurality of umbrella rib units, wherein at least one of the umbrella rib units is provided with a light groove along a length direction, a light assembly comprises a light-emitting body and a light-transmissive tube wrapping on an outer side of the light-emitting body, the light-transmissive tube is used for being completely or partially embedded into the light groove, and the light-transmissive tube is arranged along the length direction of the umbrella rib unit.

2. The outdoor umbrella with the light effect according to claim 1, wherein one end of the light-emitting body is connected to one of terminal parts through wires, each of the terminal part is used for being in conductive butt joint with one of terminal bases, and the terminal bases are located on a master control part; the terminal bases are arranged on the master control part, and each of the terminal base is used for being in fit with the corresponding terminal part.

3. The outdoor umbrella with the light effect according to claim 2, wherein the master control part is used for being in fit with the umbrella plate assembly for installation, and a power module is further conductively connected to the master control part.

4. The outdoor umbrella with the light effect according to claim 3, wherein the power module comprises a solar panel and a power storage module electrically connected to the solar panel.

5. The outdoor umbrella with the light effect according to claim 3, wherein the power module comprises a battery holder and a battery module detachably installed on the battery holder, and the battery holder is used for being in fit with the umbrella rib assembly or an umbrella column for installation.

6. The outdoor umbrella with the light effect according to claim 1, wherein a groove opening of the light groove is formed downwards, the light groove comprises a groove cavity body and clamping protruding edges, the clamping protruding edges are located at two sides of an opening of the groove cavity body, and the clamping protruding edges at the two sides are used for limiting the light-transmissive tube.

7. The outdoor umbrella with the light effect according to claim 6, further comprising a diagonal brace, wherein one end of the diagonal brace is in fit with the umbrella plate assembly, and an other end of the diagonal brace is in fit with an umbrella column; the diagonal brace is provided with the light groove, and the light assembly is arranged in the light groove in a fitting manner.

8. The outdoor umbrella with the light effect according to claim 1, wherein the light-emitting body employs LED copper wire light strings.

9. The outdoor umbrella with the light effect according to claim 8, wherein the light-transmissive tube is one of a flexible matte hollow tube, a flexible bright hollow tube, a rigid matte hollow tube, or a rigid bright hollow tube.

10. The outdoor umbrella with the light effect according to claim 9, wherein the light-emitting body in the light-transmissive tube is a single LED copper wire light string, and a plurality of LED lamp beads are arranged in the single LED copper wire light string.
